(19) United States
(12) Patent Application Publication
(10) Pub. No.: US 2003/0131355 A1
(43) Pub. Date: Jul. 10, 2003

(54) PROGRAM GUIDE SYSTEM

(76) Inventors: Richard W. Berenson, Newton, MA (US); David Sklar, Cambridge, MA (US); Adam Morton, Malden, MA (US); Jason Young, Cambridge, MA (US)

Correspondence Address: Wolf, Greenfield, & Sacks, P.C., Federal Reserve Plaza, 600 Atlantic Avenue, Boston, MA, 02210, US, 617-720-3500, 617-720-2441

(21) Appl. No.: 09/996,089

(22) Filed: Nov. 27, 2001

Related U.S. Application Data
(60) Provisional application No. 60/253,318, filed on Nov. 27, 2001.

(51) Int. Cl. H04N 7/16; G06F 3/00; H04N 5/445; G06F 13/00

(52) U.S. Cl. 725/46; 725/1

(57) ABSTRACT

### ABSTRACT

A method and system is offered for creating program grids displaying programs with time as one axis and program preference along the other. Program preference information is used to create the grid. Program preference information is gathered from client devices which may be located in set-top boxes or on personal computers. Algorithms are used to determine the best placement of programs into the grid. Program preference information may also be used to direct users to other services that may be of interest.

### Related Application

This application claims the benefit under 35 U.S.C. §119 of the filing date of the provisional application with serial no. 60/253,318 filed November 27, 2000.

### Field

This invention relates to media program guide systems.

### Background

Consumers today are faced with a bewildering array of television and other media programming choices. Programming is available in the fields of entertainment, education and training, physical activity, and many more. Within entertainment, the choices are expanding wildly, as additional programming networks and independent producers develop works for distribution along a variety of new channels, including digital cable and the Internet. Within education, universities, private training firms, and the training departments of large companies are producing new and innovative programs for delivery in person, by videoconferencing, or over the Internet. Another form of programming is commercials or "infomercials," where the intent of the programming is to encourage the purchase of specific products or services. All of these programming options have further expanded as new media have begun to emerge. For example, video has been joined by interactive-video and animation based programming.

While having choices is a great boon to consumers, having too many choices can actually reduce the value of being able to choose. Consider the "500 channel problem." When television viewers had less than a dozen channels to choose from, it was a simple matter to scan a list or grid of programming and select from among the options. Cable Television opened up a whole new array of options; as a result, viewers' search behavior changed. Printed listings and grids became less useful -- users frequently would not bother to look beyond the first dozen channels in the list. Alternatively, some users would select a set of branded channels they were likely to be interested in (for example, PBS, Discovery, and History) and scan the specific programs available on that channel. Still other users would "surf" between channels to catch "micro-previews" of what was on each channel until they found something they liked. Few users would take advantage of all the 70 or so options available on a typical analog cable system.

With the advent of digital cable and digital satellite TV came the "500 channel problem." There are now far more options than anyone can process with current show-finding techniques. Surfing is impractical; channel-branding even more important than before. As a result, very few of the additional programs now available actually reach their largest potential audience, and viewers are regularly unaware of many programs they might enjoy.

A number of approaches have been proposed to help consumers select from all the programming options. Printed linear TV listings have been replaced by a two dimensional grid, with channels down one axis and times across the other. Variations on this style have been adapted to interactive media, including the World Wide Web, cable boxes and other devices with electronic program guides.

Certain TVs, set-top boxes, and digital video recorders have adopted systems that allow a user to give feedback on a program which is then used to make recommendations for future viewing. The digital television recording system TiVo, for example, might ask a user to score a program on a scale of -3 to +3. The show score would then be imputed to the attributes of the show (genre, actors/actresses, etc.). These attribute scores would then be used to prioritize a list of programs presented to the user. However, this approach is often inaccurate since it infers a user's preferences about show attributes and can make incorrect inferences. "Collaborative filtering," a technique for generating recommendations based not on the preferences of one user but of many psychographically similar users, is prone to even greater errors in inference. Thus, no effective way has yet been developed to help consumers reliably select among a large numbers of programs.

### Brief Description of Drawings

Figure 1 is a block diagram that shows an overview of the system operations;

Figure 2 is a block diagram that shows alternative uses of programming preference information;

Figure 3 is a block diagram that shows operation of a system with video-on-demand and local content storage;

Figure 4 is a block diagram that shows use of formatted program listings information;

Figure 5 is a block diagram that shows a hardware configuration of a system that operates as illustrated by one or more of Figures 1-4;

Figure 6 is a block diagram that shows an alternate hardware configuration to that shown in Figure 5;

Figure 7 is a screen shot that shows a first format of a user preference grid used in connection with the system and operations of Figures 1-6;

Figure 8 is a screen shot that shows a second format of a user preference grid used in connection with the systems and operations of Figures 1-6;

Figure 9 shows a third format of a user preference grid used in connection with the systems and operations of Figures 1-6;

Figure 10 is a flowchart showing a method of calculating the user preference grid of Figures 7-9;

Figure 11 is a flowchart showing in greater detail the method of Figure 10 of generating the user preference grid;

Figure 12A is a table of example sorting preference;

Figure 12B is a table illustrating ranking of preference weights;

Figure 13 is an annotated flowchart that shows the method of sorting preferences;

Figure 14 is a table that shows example influences on preference score used in the methods of Figures 10, 13, and 11.

### Summary

Offered is a system for helping a user select among program options, comprising: a first device programmed to accept information from the user on programming preferences; a database which accepts and stores programming preference information from the collecting client; a server which combines information from the database with listings information and formats that information for presentation to the user; and a second device which accepts the formatted listings information from the server and presents it to the user. In one embodiment the system may have at least two first devices. In another embodiment the first device may be the same as the second device. In a further embodiment the presenting client does not run on the same device as the server. In still a further embodiment the clients communicate with the server over a wide area network. In still a further embodiment the formatted listings information is presented in the form of a user preference grid.

A method of presenting program listings information in a two dimensional grid is offered, the method comprising the steps of: creating a two dimensional grid where one axis represents the time slots in which programs are available and a second axis represents a suggested preference order of the programs in each time slot; and displaying the grid to a user.

Also offered is a computer user interface for presenting programming listings information comprising: instructions for creating a two dimensional grid where one axis represents the time slots in which programs are available and a second axis represents a suggested preference order of the programs in each time slot; and instructions for displaying the grid to a user. In one embodiment the suggested preference order is determined, at least in part, based on personal preference information. In another embodiment the computer user interface further comprising instructions to select a program and have all conflicting program options eliminated from the grid.

Also offered is a displayed time-by-suggested preference program grid.

Also offered is a data structure programmed to represent a time-by-suggested preference program grid.

Also offered is a device for displaying a program grid to a user, the device programmed to: receive program preference information; and display a grid of programs with time as a first axis and suggested preference as a second axis. In another embodiment the device is further programmed to: receive information on available programs; and generate the display of the grid from the program preference information and the information on available programs. In a further embodiment the program preference information is received from a user. In still a further embodiment the program preference information is received from a server.

Also offered is a server for generating program preference information, the server programmed to: send and receive program preference information; send and receive information on available programs; and generate and send data sufficient to create a grid of programs with time as a first axis and suggested preference as a second axis.

### Detailed Description

The system and method described below are used to generate user preference grids ("UPG") which display programming information to a user in a grid which displays programs sorted by time on one access and suggested preference along the other. Suggested preference data, in the form of programming preference information, is gathered based on inputted user preference as well as multiple other factors. The system matches the programming preference information with programs available at specific times to generate a grid which is more useful to a user than a standard timer by channel grid.

Programming preference information may also be used to direct users to specific advertisements, discussion groups, or other items which the system determines may be of particular interest to the user based on the users programming preference information. Embodiments of aspects of the invention gather preference information and present intelligent, customized programming grids to users. By combining preference information for a user from different input sources as described below, the system is able to present various choices for preferred programming for a given user or group of users.

The exemplary methods and systems make it far more practical for consumers to find preferred programming amidst a wide variety of choices. The exemplary systems work by combining information on a user's programming preferences collected through a variety of media in order to filter and prioritize available programming options before presenting them to the user. The following detailed description of embodiments of aspects of the invention illustrate a novel and useful way to obtain desired input and to obtain and present the results of that filtering process.

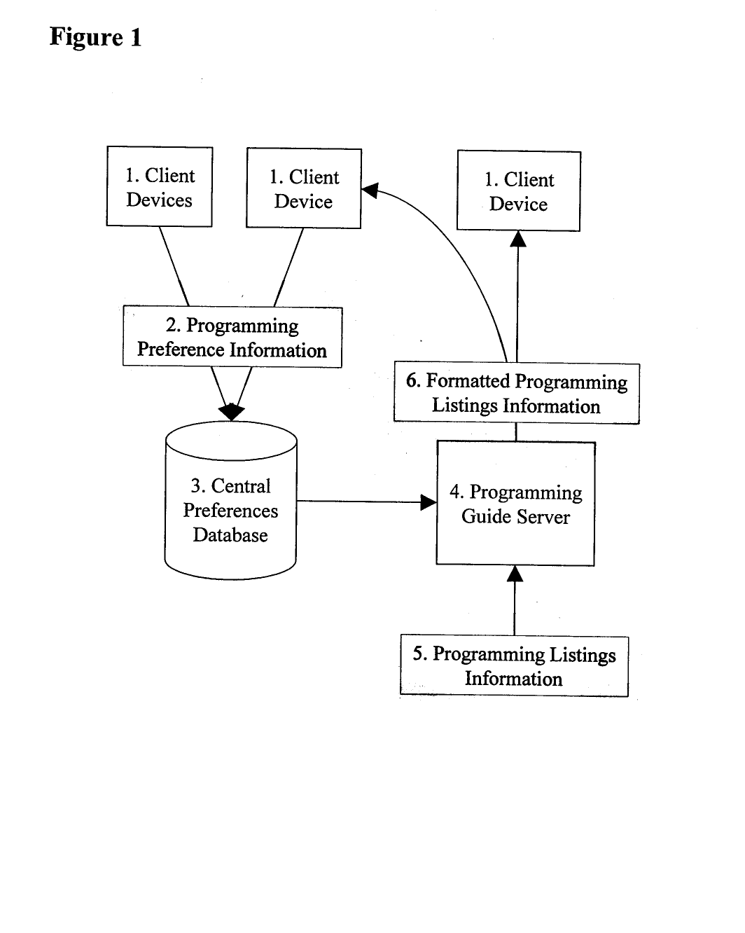

Figure 1 is now described, illustrating aspects of obtaining desired input, and obtaining and presenting formatted program preference results. Programming preference information about the user (2) is collected from one or more client devices (1). Programming preference information is data which the system uses to sort programs according to a user's preference These client devices (1) may be, without limitation, a PC running a Web browser or other application; a digital cable or other set-top device; a wireless device such as a cellular phone, two-way pager, PDA, or television remote control; an "Internet appliance;" a home automation system; or any future device capable of inputting data. The programming preference information (2) ("PPI") may include, without limitation, which programming the user has watched; which programming the user has shown interest in (for example by asking for more information about the program, perhaps through a computer user interface); how much the user liked specific programs or parts of programs (for example, rated on a numeric scale); what program series the user has liked; what types of programs the user likes; what channels the user has liked programs on, what locations, actors, writers, directors, producers or others were involved in programs the user has liked; what topics or issues the program addressed; under what conditions the user likes different types of programs; the user's schedule; and so on.

### Collection of Programming Preference Information

Portions of the PPI (2) may be collected through a set-top box and portions may be collected through one or more sites on the World Wide Web. The Web sites may collect the PPI (2) explicitly, or infer the PPI (2) from site usage behaviors relative to the programming or from general site usage behaviors. For example, product choices made at Web sites or products which the user has shown interest in may be captured by the system and processed to inter program preferences and may be included in PPI (2), as could products a user has shown interest in though an interactive television or other service.

In another exemplary embodiment, PPI (2) regarding specific parts of a program may be collected while the user indicates approval or disapproval during the showing of the program. This indication may be made by the user typing information, manipulating a pointing device, using a remote control device, gesturing, providing biofeedback, or by any other means. In one embodiment, the system may then examine closed captioning information, program time-counters, other embedded tags contained in the program transmission, the time of the transmission or other factors to determine what aspects or portion of the program the viewer liked or disliked.

Program attributes preferred by the user may be further elicited by presenting the user with a menu of show attributes for manual ranking. This is particularly useful when a show has many characteristics, a different subset of which might be liked by different people for different reasons. For example, some people may prefer a show for its dark humor, while others may not prefer the dark humor but may prefer the actors. In one embodiment, the system prompts the viewer to indicate which attributes of the show he or she likes, for example through a pop-up dialog box or other interface, thus avoiding the false inference that the second type of viewer prefers dark humor because he or she prefers the show.

The system may allow for some client devices (1) -- particularly set-top boxes, Internet appliances, and others designed to be used by groups of people -- to be aware of their multiple users and distinguish between those users through unique personalities. According to one embodiment of the system each user of a multi-user client device (1) may have a personality, identified either by a generic name such as "Mom," "Dad," or "Baby" or by a self-selected username. Each personality may be tied to a unique set of PPI (2) for that user. In a situation where multiple users wish to watch programming together, the client device (1) may record which personalities are present, and would find and display formatted program listings information ("FPLI") (6) that fits all users' PPI (2). Thus the client device (1) may display programming that all personalities present are likely to agree upon.

The PPI (2) of multiple users may be correlated across a wide area network. Using a computing device (such as a PC with a Web browser) a user may create a list of friends' personalities and easily find programming that fit all their PPI (2). Alternatively, a user may create multiple personalities in order to represent their friends when selecting programming for them to share. Personalities may also be showed by the system with other services, for example, such as match making of affinity groups.

Additionally, each personality may have unlimited moods, variations of the user's PPI designed to recognize that viewer preferences change with certain factors. Examples of moods may include "Sunday Afternoon Sports," "Something Romantic," "Light and Funny," "Heavy Drama," "Family Time," or anything else a user created. Selecting a mood would display only the FPLI (6) associated with that mood's PPI (2). The demographic and technical settings of the user would be consistent across their moods. In one embodiment, once a user specified a mood, any changes they made to their PPI (2) (such as through real-time indication of approval or disapproval) may only affect that mood's settings.

Referring again to Figure 1, the PPI (2) is transmitted to and stored in a central preferences database (3). In one embodiment, the PPI (2) is transmitted over a wide area network, such as the Internet, a cable television system, the telephone system, a fiber optic system, or a wireless system. The programming guide server ("PGS") (4) uses the information in the central preferences database to filter the program listings information ("PLI") (5) before formatting it for presentation to the user.

"Filtering" by the system may include determining which program options to present, the order in which the options are presented, how the options are presented graphically, as well as other options. It is within the scope of the system that the filtering may also consider factors other than the PPI (2), including without limitation, promotional activities or payments by the program promoters. In one embodiment, the user may review his or her PPI (2) through one or more client devices (1) and delete, reset, or modify the PPI (2).

In a preferred embodiment, the filtering uses PPI (2) from multiple sources to produce a list both of recommended programs and/or, optionally, of recommended channels. For example, the order in which the programs are listed may be based first on series preferred by the user (excluding episodes already seen), then on genres liked, then on actors liked. Programs listed may be restricted to those shown on a set of "preferred channels" (e.g., to eliminate channels the user does not receive) and/or to those the user has not explicitly designated "do not show me." A channel may be placed in the search order if it has a sequence of programs that all match a user's preferences or if the channel has paid for a placement.

Filtered PLI may be formatted in a wide variety of ways. The formatted program listings information ("FPLI") (6) is passed on to a client device (1), which may or may not be one of the same devices from which the PPI (2) was collected. The FPLI (6) may be formatted using a tagging system, such as SGML, HTML or XML. Alternatively, the FPLI (6) may be formatted differently depending on the client device (1) used to present the results to the user.

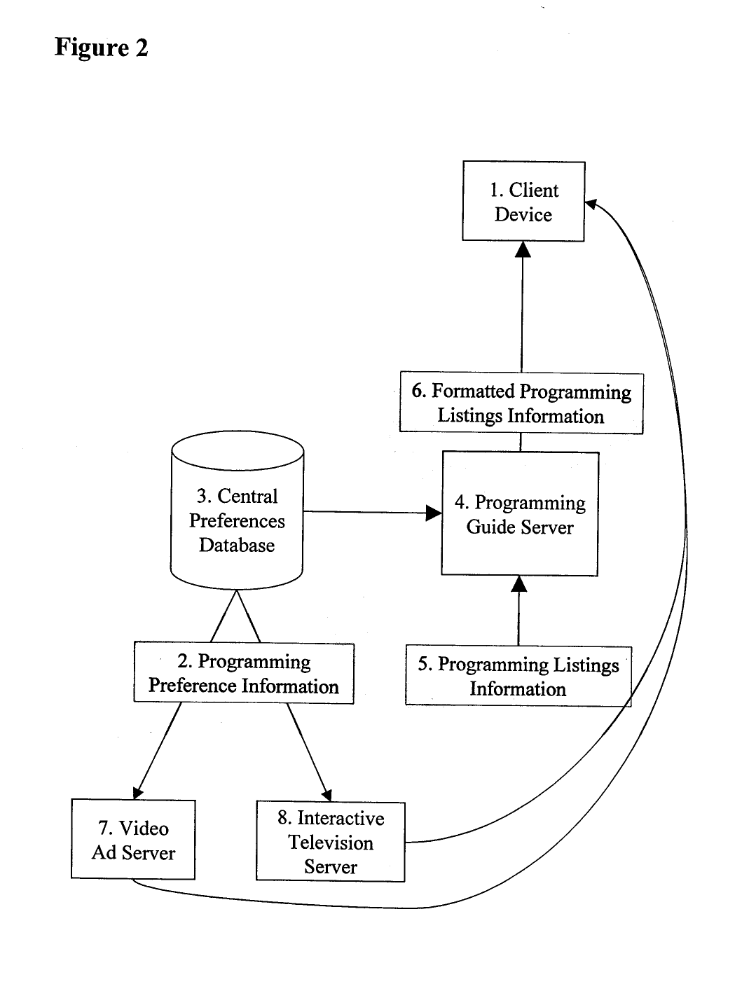

Figure 2 shows how PPI (2) may also be used for other purposes. For example, a user's program preference may be used to direct certain advertisement to the user. Directed advertisements may take the format of "banners" which appear with a presentation of the UPG, or may take the form of commercials which one specifically targeted to users with particular preferences by an interactive television service PPI (2) may be passed on to a video ad server (7) or an interactive television server (8) respectively.

The system may acquire the lineups and listings data which comprise the PLI (5) for the relevant region, for example, the U.S., Canada, and / or the UK. New data may be received from a data supplier every morning (for example, at about 2 a.m.) that provides an up-to-date set of listings for the next two weeks. Alternatively, or additionally the system may receive monthly data for a subset of channels on a fixed date, for example the 15th of each month, for the next month. The data arrives, for example, over the Internet in delimited text files that the system processes, indexes, and inserts into its listings database (not shown). Once the processing has completed, the data is copied out to live database servers. The importing routines may handle different countries' data separately. While the system is optimized to handle the input files in the format in which the data supplier provides them, it may be easily adapted to receive data from additional (or alternative) providers using other data formats.

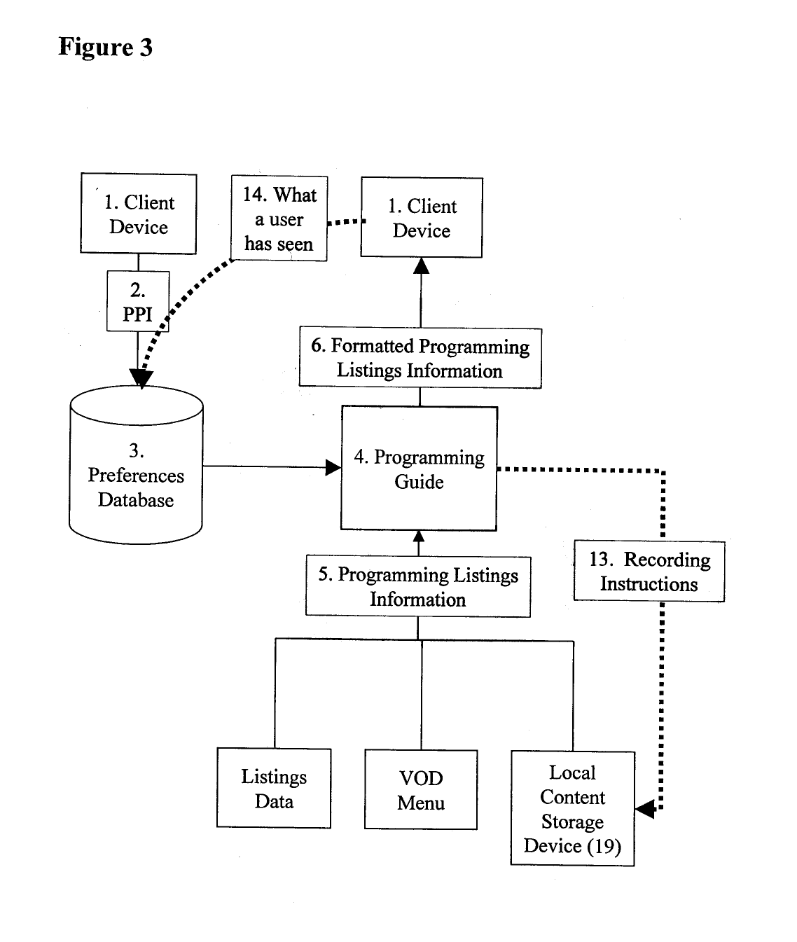

The system may also incorporate other programming sources as illustrated in the embodiment shown in Figure 3. In Figure 3, feedback is represented by a dashed line. Here PLI, (5) includes not only listings data about scheduled programming, but also the menu of programs available on various video on demand ("VOD") systems (also known as "pay-per-view systems") and/or the list of contents of locally recorded and available on demand programming -- such as that which has been recorded on a video recorder, or more particularly on a digital video recorder ("DVR"). On demand programming data is incorporated into the FPLI (6) by the programming guide server (4) by assigning each available time/program combination its own channel and using existing algorithms. However, the prioritized list of shows may also be used to trigger automatic recording (13) by the local content storage device (19) (e.g. a DVR or video cassette recorder ("VCR")) of high priority programs which might not otherwise be available when a user next wants to watch programming. This, in turn, may change the PLI (5) and the FPLI (6) (e.g., the user preference grid described below). Further feedback may occur when a user actually watches a program (14): VOD or local content programming which the user has already seen but which might otherwise have a high recommendation priority would receive a much lower rating and therefore, for example, not appear very high on the UPG. Information on what the user has seen may also be used to instruct the local content storage device (19) which existing content to delete in order to make room for higher priority content.

### Interacting with the FPLI

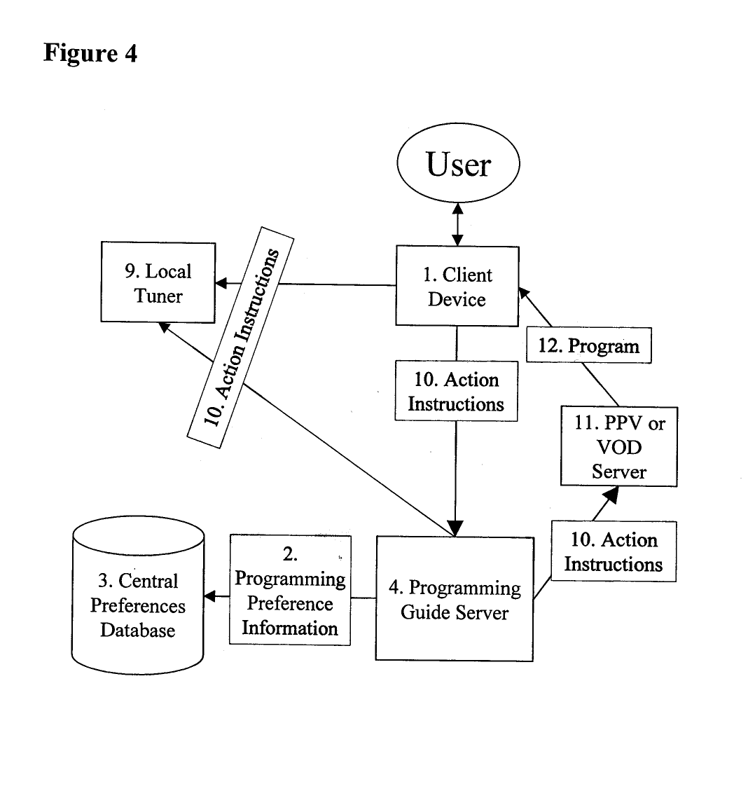

Figure 4 shows how the user may interact with the FPLI using the client device (1). One result of such an interaction may be selecting a program for preview, display, or recording. This selection information may be relayed directly to a local tuner (9) in the form of action instructions (10) that select the program from a number of programs being transmitted to the tuner (9) and takes the appropriate action. Action instructions may include instructions to change the channel now or at a future time, turn hardware, e.g. the television, on or off, record a program, delete a recorded program etc. Alternatively, action instructions (10) may be relayed to, or generated by, the programming guide server (4) ("PGS"). The PGS (4) may then transmit a program preview or transmit the action instructions (10) back to the tuner (9), which would then select the appropriate channel and take the appropriate action.

The selection may also be relayed through the PGS (4) to another device that selects which program the user will receive. For example, the action instructions (10) may be relayed to a pay-per-view or video on demand server (11) which would, in turn, grant the user access to the selected program (12). The selection information may also be relayed to a recording device, (which may not be the same device as the local content storage device (19), which would then store the program for later viewing. The selection information may also be relayed to the central preferences database (3) as PPI (2).

As described above the system may share PPI to provide other services to the user. In examples of such arrangements, user interaction with the FPLI may also cause the system to, without limitation: submit PPI (2) to the central preferences database (3); initiate a text, voice, video or other type of electronically mediated interaction between users of client devices (1) where the users have a specific interest in common and where, optionally, that shared preference has been identified by the users' interactions with the FPLI; send an e-mail, voice, wireless, or other form of message to someone known to the user, either recommending the program to them or inviting them to watch the program with the user; and / or allow a user to participate in an activity being shared by those viewing or planning to view, or having viewed the program, including without limitation, placing a wager, giving an opinion, expressing a preference, making a selection, or giving feedback, including real-time feedback, to those producing the program.

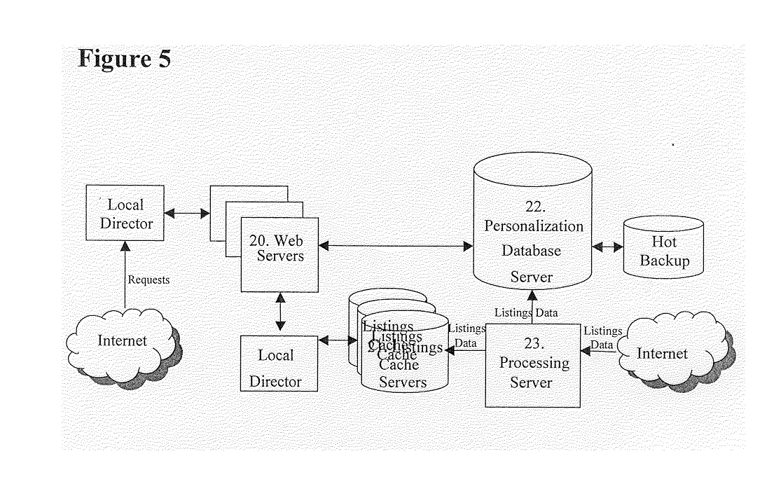

The hardware configuration of Figure 5 is now described. The physical infrastructure scales easily and cost-effectively while providing maximum reliability. It may employ single and dual processor Intel machines running Linux, although the core software, for example, including Apache, PHP, and MySQL, may run on many other Unix-based systems and Windows, as well as other processor architectures. The machines used fall into one of four classes:

The web servers (20) assemble documents from pieces of data and deliver them to users' browsers or set-top-boxes. The web servers (20) each contain identical data and sit behind a Cisco LocalDirector, or any similar switch, to provide load balancing and failover. A content management system automatically updates all Web servers in parallel when publishing new versions of system. The LocalDirector makes sure that sessions started with one web server continue with that web server. Multiple Local Directors are shown in Figure 5, but they may be one Local Director depending on the arrangement of the hardware at each particular location.

The listings cache servers (21) host a database of lineups and listings data that is read-only to the processing server (23), and that is updated regularly by the processing server (23). The listings cache servers (21) are also clustered behind the LocalDirector. They handle grid display and search requests.

The personalization database server (22) builds a read-write database of user-specific personalization data, such as, for example, member accounts and settings, programming preferences, ratings, and similar information. Because this user specific data is constantly changing as users perform various operations on the site, it is not simply be mirrored with the LocalDirector. However, the read-write database server has an identical hot spare that updates automatically. A hot spare is a live machine which is always running and ready to pick up the work if the main machine fails. Failover to the hot spare may be performed manually or automatically as known in the art.

The processing server (23) downloads new lineups and listings data regularly and inserts them into its database. The processing server (23) then copies those database files to the listings cache servers (21) and signals those machines to use the new data. Additionally, the processing server handles reminder/alert processing, as detailed below.

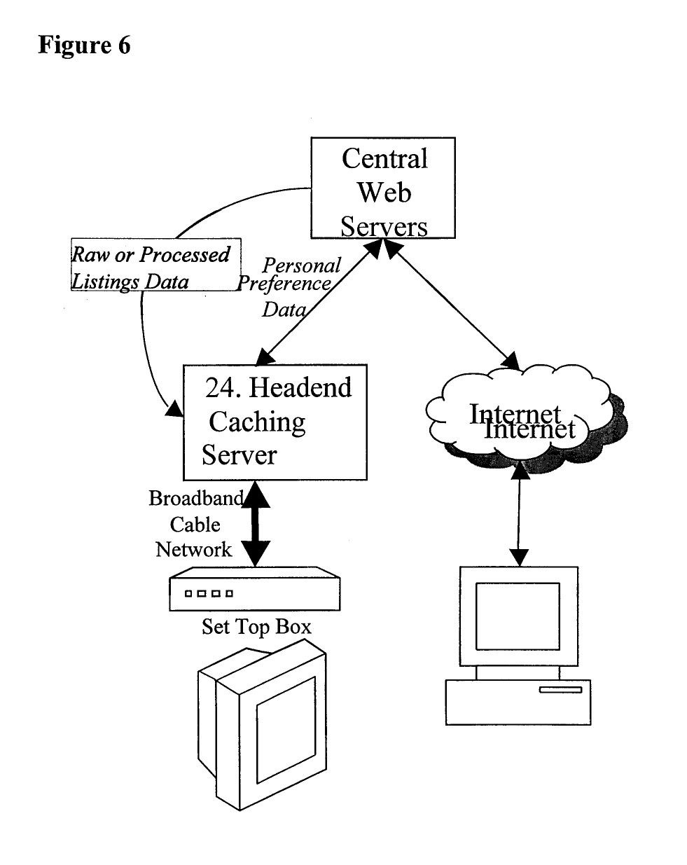

Figure 6 is now described, showing how headend or cable system-specific installations may use pared-down hardware configurations, including combining different functions on the same machine, if space available or the functionality desired by the cable system warrant such measures. A headend is a central hub for cable television which serves homes in a particular area. An installation may be comprised of zero, one or more physical deployments. A physical deployment is where a server is set up in a physical location. Multiple physical deployments may be made to improve response times by placing servers close to users.

Headends receive programming and remodulate it onto the cable for distribution. Depending on the level of service desired and the audience to be reached, the system may employ aggressive caching techniques to serve a large number of users with comparatively little hardware. In a deployment located at a cable system headend, the system need only download and use the data relevant to that particular headend, which results in significant savings in data importation time and search processing. Additionally, because restricting the data set to relevant to only that one headend, and having the display customized to just that one call system partner, reduces some of the most significant barriers to caching, it is possible to pre-generate and cache pages that contain grids and popular search results. The reduced hardware cost becomes particularly attractive in a set-top targeted deployment because of the high peak-average use ratio of an on-screen programming guide.

The system can be made flexible enough to work on different platforms, such as the Web and set-top-boxes. The system includes a well-organized presentation engine for matching what programming is available and what users want to watch. That engine may be configured to fit to many different display paradigms. For example the system may easily be configured and formatted for display through a PC, through an internet device, on a wireless tablet, or through a set-top-box. The transition from the Web to the set-top is facilitated by the development of standards like Advanced TV Enhancement Forum ("ATVEF") that facilitate the transition of hyper-text markup language ("HTML") set-top interfaces with a minimum of new code.

Configurations for the set-top may be server-based for greater efficiency. The only software needed on the set-top-box can be a basic browser, for example Device/Mosaic, that supports HTML, JavaScript/ECMAScript, ATVEF, and cookies. (ATVEF 1.0 includes support for the other items mentioned). By using only a browser, set-top-box resources are freed up for other applications which providers or users may wish to run. If additional features, such as a DVR, are available, the system may be configured to take advantage of them, but such features are not required. The system may be able to support some DVRs with no additional box-resident code.

Certain functionality, such as channel changing, in either the set-top-box or on the server. Set-top-box channel changing functionality may be accomplished through a browser plug-in or appropriate ECMAScript code, while server-based functionality causes redirects with standard ATVEF commands.

If the connectivity is supplied at the headend, installations may be made to function across both the set-top-box and Web delivery platforms. This is beneficial for user convenience, as users may access their listings anywhere, and is particularly helpful for diverse preference gathering. Explicit preferences gathered on the Web and implicit preferences gathered from set-top usage and viewing data may be combined to further enhance an individual's preference data.

Physical deployments of the system, whether at facilities for performance or redundancy or at multiple cable system operator headends or similar locations for customer requirements, may also receive a daily input of data. Depending on the customer needs, these additional installations may be configured to "piggyback" on the main installation and receive processed data ready for insertion into their own databases, or retrieve the raw input files and do the processing on their own. The former method works better for installations that need less maintenance -- they wouldn't need to be updated with new processing code. The latter choice may be particularly appropriate for in-headend installations, since the processing may be restricted to just the subset of lineup and listings data for that headend, which speeds processing and conserves incoming bandwidth. Since there are currently over 13,000 headends in the United States, trimming down the data processing to just 1 or 2 headends for a specific installation may provide a number of efficiency gains, not just in data processing, but in search and overall site performance. While there are about 1.5 million airings of programs in North America in any two weeks, each headend has only about 50,000 airings. Much of the data storage requirements for a single headend installation may be scaled back close to that 25x linear relationship.

### Presentation of Lineup Information in a User Preference Grid

In one embodiment, the FPLI may be presented in a grid, where time slots are represented by columns (or rows) and the rows (or columns) represent the suggested preference order of the programs. The user preference grid, UPG, is, instead of a conventional time-by-channel grid, a time-by-preference grid. The UPG is designed to have an initial level of usefulness for users for whom we have no preference information and to grow more valuable as it gathers preference information has been gathered from a user.

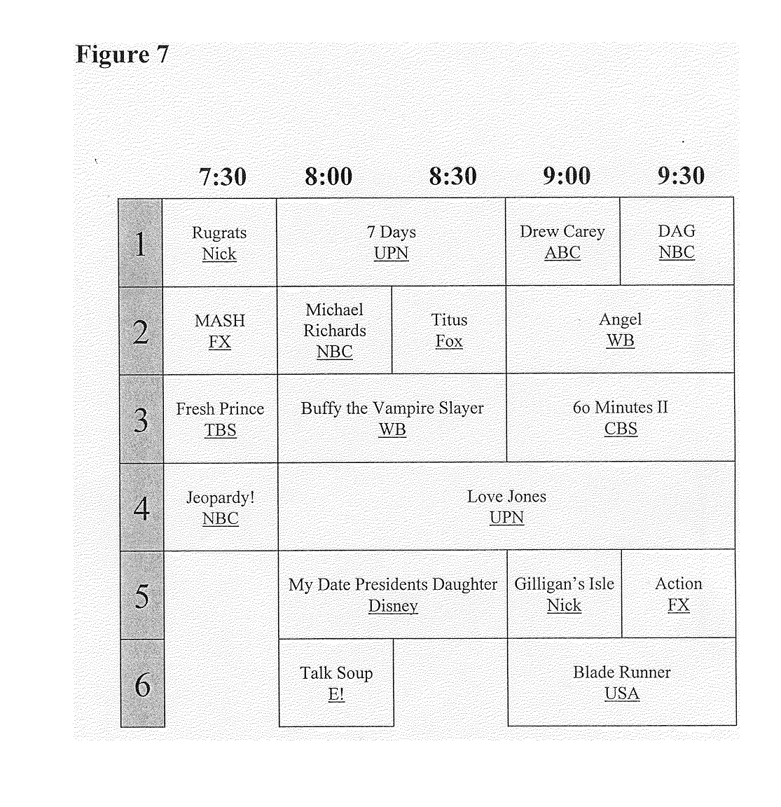

Figure 7 is an illustration of such a presentation. This particular illustration shows an evening's worth of recommendations for each viewing time slot. Although other methods are possible, the grid may be assembled as follows: all possible programs in a period are ranked according to the current preferences; the programs are then placed sequentially into the highest uninhabited slot for its time period on the grid. Examples of such methods are disclosed in detail below. In the illustration in Figure 7, the PGS has determined that "7 Days" best meets the current preferences of the user, and so lists it first in the 8-9 pm time slot. The second choice in this slot is "Titus." However, since "Titus" does not fill the entire time, the PGS has identified another program, "Michael Richards," as something to watch from 8:00-8:30. "Buffy the Vampire Slayer" is ranked lower than "Titus" but higher than "Michael Richards," but "Michael Richards" gets listed first because a higher slot was available when it came time to slot it into the grid. An alternative embodiment would have "Michael Richards" listed below "Buffy," leaving a blank space before "Titus."

A user preference grid may, optionally, list a variety of information in each grid box, displayed in the form of text, icons, or images. The grid may also have a variety of interactive features, including buttons or hyperlinks which may initiate actions, including, without limitation, bringing up more information on a program or a channel, entering PPI (2), requesting that a program be previewed, displayed, or recorded, and so on.

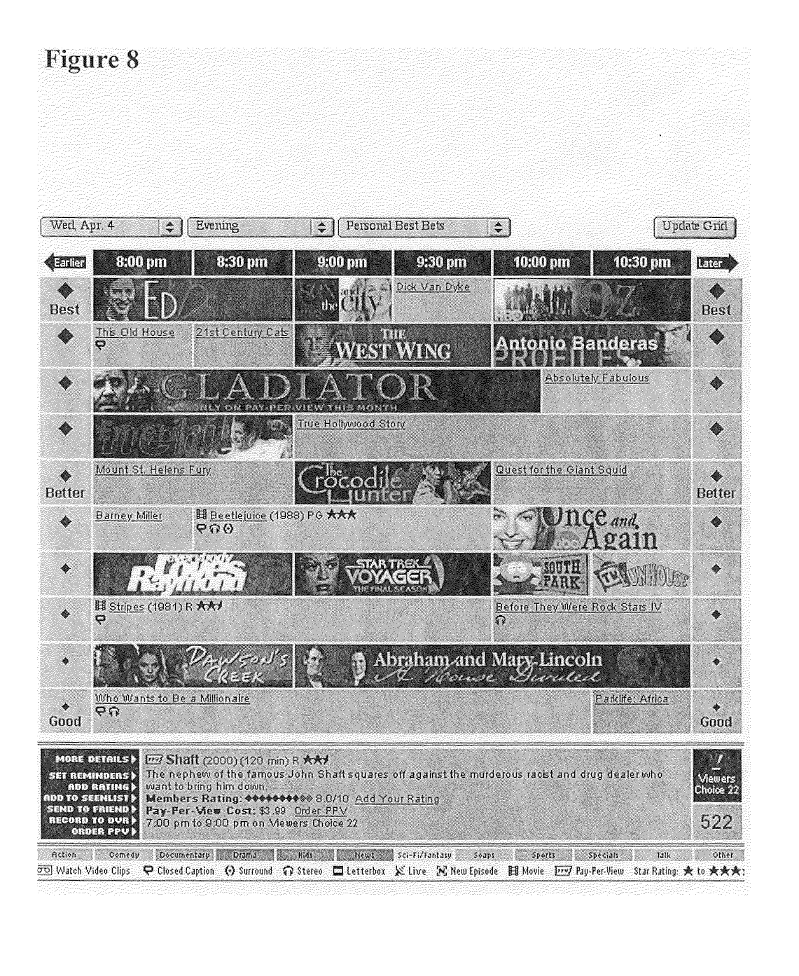

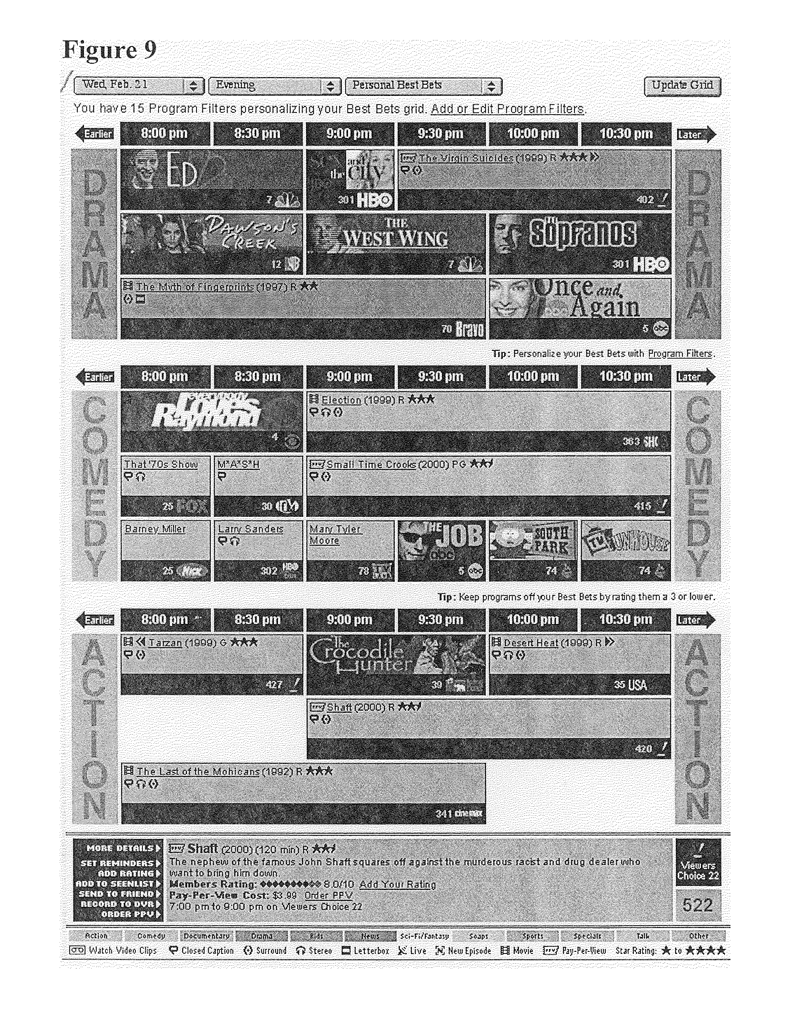

Figure 8 such a grid. The series of programs that appear on each line of the grid are made up of programs that may air on different actual channels. Figure 9 shows an alternative UPG, wherein personal lineups are grouped by genre, mood or any other characteristic. Alternatively, time might be displayed down the side and preference or genre be displayed primarily or secondarily across the top. It should therefore be evident that the invention of the UPG encompasses a wide variety of grid displays where channel is not a geometric dimension of the display.

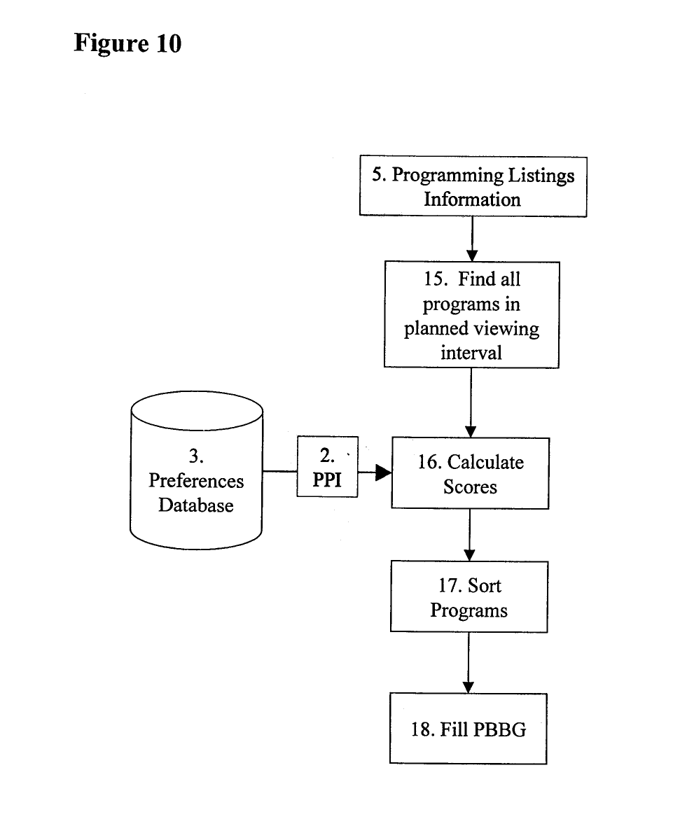

A method of computing a preference grid is now described in connection with Figure 10, to display the UPG the system finds all programs that are on in the specified time interval (15)--usually a few hundred for a three-hour grid--and sorts them (17) by a pre-computed score. Programs that have not already been scored are assigned a score (16). Programs with higher scores are moved up to personal lineups on the top of the grid, while programs with lower scores are pushed down and possibly off of the grid.

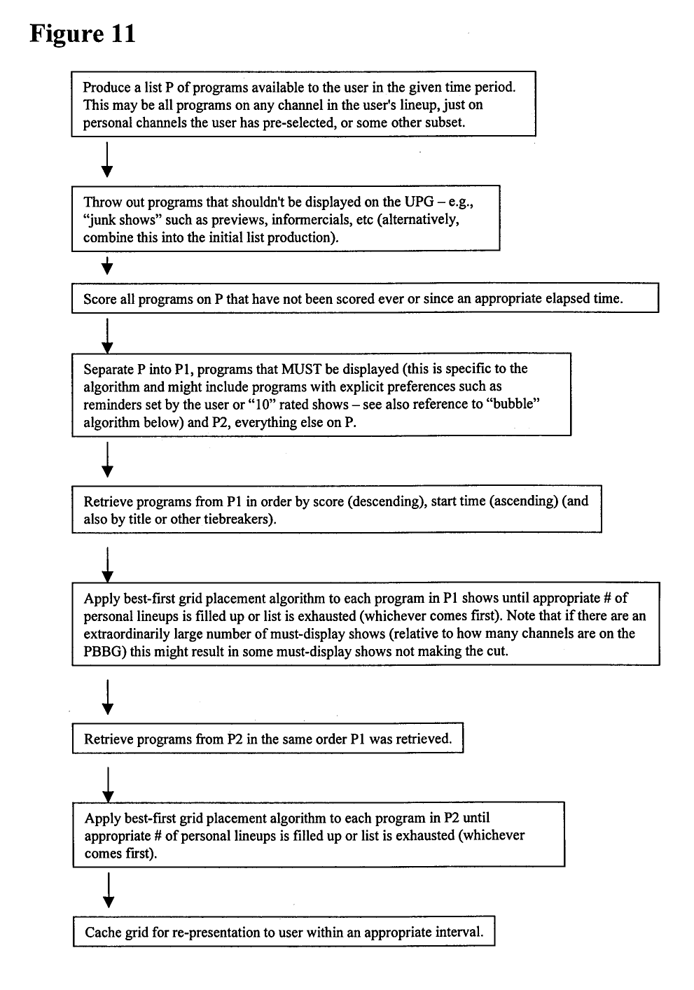

An algorithm for producing the user preference grid is now described in greater detail in connection with Figure 11. The best-first placement algorithm in step 5 of Figure 11 assumes that the programs are sorted by score (best first) and start time (earliest first). The algorithm attempts to place each program on the lowest-numbered, i.e. best, UPG program series. The sorter iterates through each personal lineup, starting with the first one, until it finds a UPG personal lineup with nothing already present during the time window that the to-be-placed program occupies. If, after checking the highest-numbered, i.e. worst, UPG personal lineup, the sorter still is not able to find an unoccupied spot for the to-be-placed program, it discards the to-be-placed program and moves on to the next program, attempting to place it at the lowest-numbered personal lineup.

The available programs to place on the grid can be filtered or preselected. For example, programs with a short duration (e.g., less than or equal to 15 minutes) may be excluded from the UPG. This may be adjusted, and may not be necessary when there is enough data to be placing shows based on sufficiently valuable user preferences, which may exclude tiny-length shows.

Alternatively, a user may interact with a user preference grid as follows. A user may indicate a specific program the user intends to watch. The system would respond with a revised user preference grid which eliminates any shows that conflict with the one selected. In the example shown in Figure 7, Selecting "Titus" would cause the system to eliminate "7 Days," "Buffy the Vampire Slayer," "Love Jones," and "My Date Presidents Daughter" from the grid.

Another type of algorithm modifies the order of the representation of a specific television or other program after the order has been established by moving a particular show up in the order by a certain number of positions if it meets certain criteria. This algorithm would allow explicit criteria to override other criteria -- or to allow a relationship in the order between the importance of the influence which affects specific programs and the order in which the programs appear in the grid. For example, specific searches may cause programs which meet certain criteria to appear at the top of the grid. This may also accommodate charging a fee to ensure a program appears in the top 10 program series.

The computation of a program's score starts with a number of generic sources, such as aggregate user data, imported external data (e.g. Nielsen ratings), or paid promotional placements from partners, programmers, or producers. This ensures that even the first time a user looks at his or her UPG, it is presenting a reasonable filter over all available programming that immediately makes it more useful than a standard time-by-channel grid.

To personalize the grid beyond the aggregate ratings, the preferred UPG score computation also uses implicitly gathered preference data collected on the Web or through the set-top-box. This implicit information is used to infer preferences based on a set of rules about relationships between television programs. These relationship may include everything from linking movies and their sequels to shows with common characteristics, such as "The Simpsons" and "Futurama."

The score computation may rely heavily on explicit preferences. Explicit preferences may be very specific -- the system knows a user likes a particular show because he or she has rated it very highly -- but they may also be much broader. Personal searches are explicit queries which a user enters to identify specific types of programs in a database of programs. For example, personal searches may generate broad explicit preferences such as "user likes movies directed by John Frankenheimer" or "user likes the Boston Red Sox." Additionally, different actions triggered by personal searches may affect the score computation differently. For example, if the user asks that the results of the personal search be put into the user's calendar, that result would scores higher than if the user only requests that the results be sent in an e-mail.

The UPG architecture is flexible in that it allows the system to begin with generic data and move to successive levels of more and more precise user-specific data. Another important flexibility is that the score computation algorithm itself is extensible. A current set of data inputs and weights may be augmented or replaced as new kinds of data items or ways of relating them become available. As the interface to television changes with enhanced set-top-boxes, the system may be able to learn more about who is watching television at a particular time, for example. The UPG algorithm structure is able to assimilate this kind of new data input.

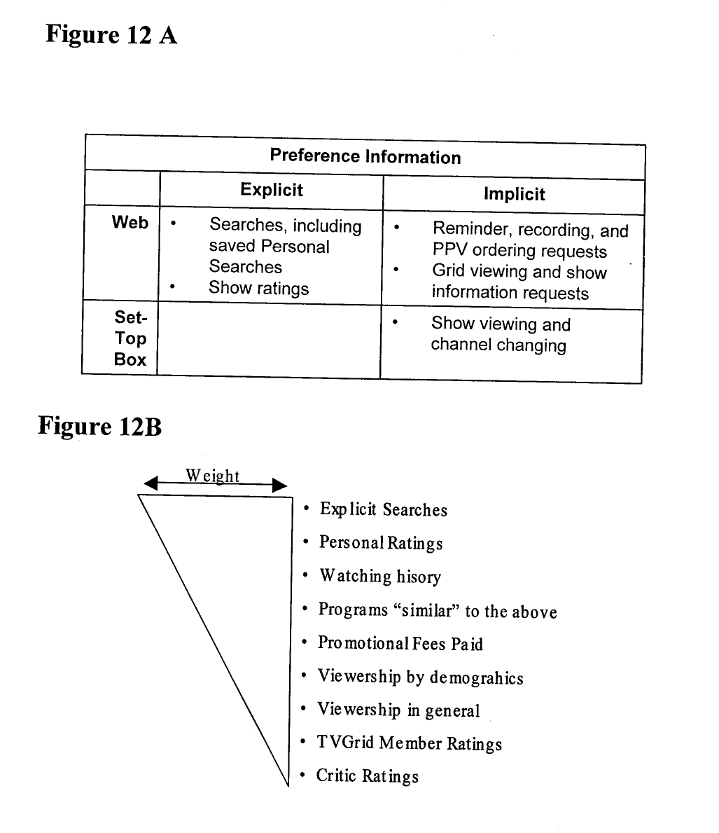

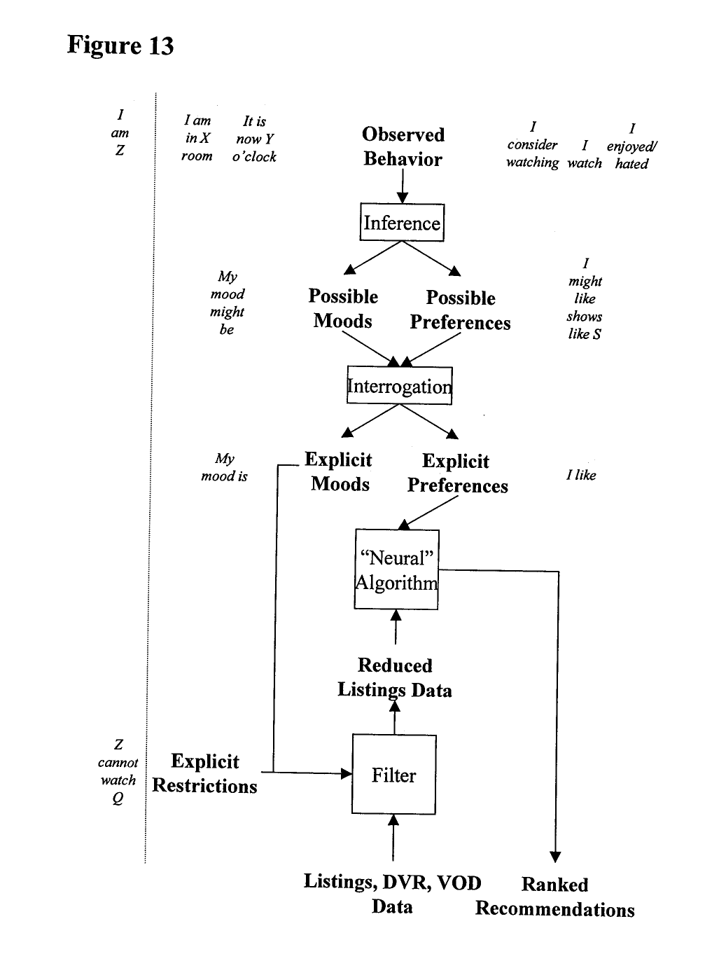

Figures 12A and 12B illustrate in tabular certain types of preferences and how, in one embodiment, they are relatively weighted to produce an aggregate preference score. Figure 13 shows an algorithm for producing ranked program lists from preference information according to another embodiment.

Many factors may influence the score for each program. In any particular implementation of a scoring algorithm, those influences may be included or excluded. Further, each influence may be given a weight or put into a "weight bucket," indicating how important that influence will be in calculating the score. A weight bucket is a collection of characteristics all of which get one of a limited number of weights when calculating the score. Figure 14 shows a table of certain example influences.

A program's score may be computed using a variety of approaches, including:

Additive: each score influence contributes some amount of points to the score. Each influence may or may not have the same max contribution amount. Contributions may be negative. There may or may not be a maximum negative amount.

Multipliers: some influences instead of/in addition to being additive elements may be applied as a multiplier after all of the additive elements have been computed. For example, after other influences are totaled, the score may be multiplied by the rating (or by the rating subtracting a modifier to give lower ratings the effect of making the score negative to reduce the likelihood of those programs appearing in the UPG).

Relationships: as mentioned above the score of a program may be influenced by information about other programs that have some kind of relationship to the program in question. Relationships may include, without limitation, being episodes in the same series, being a sequal / prequal, belonging to the same genre or sub-genre, featuring the work of the same actor, director, or writer, marketed toward the same demographic target, featuring similar themes, same team or town (for sporting events), being rated the same by some individual or group, or sharing any other characteristic.

For example, if a user has a (high/low) score with regard to other programs in the same series as an eligible program, that eligible program may have a (higher/lower) score. The scoring algorithm may explicitly add points to the score of a program in a particular series if a user has rated (or indicated they have seen or gotten reminders about) other episodes of that series. If an eligible program belongs to a series, the scoring algorithm may or may not check how many reminders exist / what the ratings are for other programs in that series (for the given user) and adjust the score correspondingly.

Many other algorithms are also possible and may be used by the system. For example:

Generic scores are used to score a program on a user's grid when there is nothing user-specific known about that program. Only programs get generic scores. Each program generic score is the sitewide average rating of that program (if the program has more than a certain number of ratings) * 100 (to scale the score between 0 and 1000 for a 10 point rating scale). In one embodiment program with 5 or fewer ratings do not get generic scores.

Seed scores are independent of time and channel. They are used to provide a starting point for user-specific program scores. Seed scores may be applied to category, program type, and the series. The seed score computation starts with the program that a user has reminders for or has rated. Then, category, program type, the series is retrieved for each program.

Some information may be collated about these program:

· how many shows fall into each category, program type, the series

· how many rated shows fall into each category, program type, the series

· the total rating for each category, program type, the series

· how many reminders fall into each category, program type, the series

· the total number of reminders

Then, scores may be computed. For each category, program type, and series there are two components: the rating component and the reminder component.

The rating component is the average rating for the item, scaled to 1000 (i.e. multiplied by 100) * weight for ratings/10. (The weight is divided by ten to provide a consistent scaling of scores. The same result may be achieved by not dividing the weight by 10 here and instead having the weight selections on the scoring page range from 0 to 1.)

The reminder component is the number of reminders for that item / total number of reminders, scaled to 1000 (i.e. multiplied by 1000) * weight for reminders/10. The score is the sum of the rating component and the reminder component. If both components are used in the score computation, then the score is divided by 2.

Grid scores incorporate existing scores (seed and otherwise) to score the appropriate programs in a particular time window and channel set that a user requests. To compute grid scores, first some necessary information is loaded:

· existing scores for the user

· existing generic scores

· user's reminders

· user's ratings

· user's personal search information

· id, title, genre, category, and category group id

· personal searches with a title that are not contains matches are "narrow", other searches are "broad"

Then, all the program in the grid are retrieved:

· programs that start in the grid interval, are greater than or equal to a certain length, e.g. 15 minutes long, and are on the desired channels.

Each program score is the sum of its score factors divided by the number of participating score factors. The score factors are scaled to provide a score contribution between 0 and 1000 before being altered by the appropriate weight. Score factors include:

Rating: 100 * user's rating for the program * rating weight/10

Reminders: 20 * number of reminders for this program * weight / 10 (If there are more than 50 reminders for this program, the number of reminders (for scoring purposes) is set to 50. If the personal search that generated the reminder for this program is "broad", then the weight to use is set to the "broad" weight. (Same for "narrow.") If the reminder for this program is not from a personal search, then the weight is set to the reminders weight.)

Category, series, program type, channel: existing score for this factor * factor weight / 10

Rules: Depending on the embodiment certain rules may add points based on scores the user has for program related to the current program.

Generic: generic score for the program * generic weight (if none of the above factors are used, then the generic score factor is used).

As mentioned above, the program score is divided by the number of participating score factors to scale the score between 0 and 1000. If the user's rating for the program is high, for example 10, or the user has a reminder for the program, then the program may be set to "must include" for mandatory grid inclusion.

The score for the program is then saved. The total score for the channel that the program is on is incremented by the program score and the count of programs for the channel is incremented.

After all the program scores are saved, the channel scores are updated where each channel score is the average score of the shows on that channel.

Elements of grids may be pre-calculated. When a user requests a grid of their personal channels from 8 p.m. to 11 p.m., the grid generator does not then ask the database: "what shows are on these 27 channels that start between 8 and 11 tonight, or start sometime before 8 but don't end by 8?" That information has already been calculated (and is recalculated where necessary when new data is put into the database). Instead, the question the grid generator asks the database is more akin to: "on these 27 channels, what shows appear on an 8 p.m. to 11 p.m. grid?" The pre-calculated data may be optimized to include all of the information that is necessary to render a cell on the grid -- title, rating, etc. Additionally, the data is tagged with characteristics like genre, to make it easy and efficient to display grids that don't include every show on each channel displayed -- perhaps just a grid of comedy shows, or of movies as shown, for example, in Figure 9.

When these grids are pre-calculated, program start and end times may be rounded-off to 5 minute boundaries, speeding and simplifying display of grids as well as permitting partner-, platform-, and user-adjustable grid time width. Three-hour grids are usually the preferred width for most users on the Web but on the set-top-box, a shorter width (e.g. one hour) may be more appropriate given the lower resolution. Alternative platforms may support different grid time widths which are optimal given the different qualities of the alternative platforms.

The grid pre-calculation also provides for inclusion of paid-placement in-grid ads, in which the typical text of the program's title is replaced with a customized graphic for the show. These in-grid ads can be adjusted daily and detailed statistics are tracked on user response to them compared with the standard text grid cells. Examples of grids including these graphics are shown in Figure 8 and 9.

The user preference grid described may also be implemented on a variety of platforms, including on a system similar to the one described above but which uses only a single client device (1) (such as a Web browser or set-top box) for collecting and displaying, or on a stand-alone application running on some kind of computing device (such as a PC or set-top box) which has access, either locally or remotely, to databases of personal preferences and program listings. Thus the present invention encompasses a system similar to known systems wherein the presentation of program information is in the form of a user preference grid, rather than in the form of a time-by-channel grid.

It should be clear from the above description, that the system may be applied to any kind of programming, including without limitation entertainment, educational, commercial, and physical activities. For example, users may be asked to provide PPI (2) relative to commercials. The PPI (2) may then be used to filter a list of potential commercials and change the list of commercials that would be presented to the specific user. In an alternative embodiment, users may select among commercials that would be presented to them. These commercials may augment or replace commercials that might otherwise be presented to them. Alternatively, the user may be paid or granted a discount for watching commercials.

The system described may be able to accept PPI (2) from multiple client devices (1). Different client devices (1) are better at collecting different types of PPI (2). Set-top-boxes are best at collecting immediate feedback on preferences, but are typically poor at accepting textual or form-based information. This is because of their limited screen resolution and because of the poor accuracy and limited flexibility of the remote controls typically used as input devices. Form-based input may be the best way to learn about certain preferences of users for example about genre's, actors, and series. Web browsers running on PCs, on the other hand, excel at textual and form-based information, but are not ideal for immediate feedback. By collecting different information from each of the sources, the system may more easily assemble the diverse PPI (2) required to effectively filter PLI.

The user preference grid also offers a significant advance over previous attempts to display listings information. Previous attempts were merely efforts to make interactive versions of existing, print-based display devices. The user preference grid uses PPI (2) to create a programming grid which is customized to each individual. Further, by eliminating the channel as a key organizing factor, the user preference grid is able to highlight programming options which might otherwise be buried towards the bottom of a list or grid.

The user preference grid is particularly useful as the number of channels increases: a simple glance at the newspaper's television listings grid shows how difficult it is to find programs when there are only between 50 and 100 channels to choose from. When there are even more channels, this task becomes nearly impossible. Making an interactive version of a time by channel grid does not solve the problem, since a user must scroll or page through hundreds of channels to find programming of interest. Schemes which sort the channels in some order other than numerical order are not satisfactory because they fail to uncover programming available on channels which would not otherwise be examined. The user preference grid solves this problem by displaying the most attractive programs for that person without being constrained by the channel they are showing on.

The present invention has been illustrated by description of a number of embodiments thereof. However, numerous modifications, which are contemplated as following within the scope of the present invention, should now be apparent to those skilled in the art. Therefore, it is intended that the scope of the present invention be limited only by the scope of the properly construed claims appended hereto and the equivalence thereof.

What is claimed is:

Claims

1. A system for helping a user select among program options, comprising:
a first device programmed to accept information from the user on programming preferences;
a database which accepts and stores programming preference information from the collecting client;
a server which combines information from the database with listings information and formats that information for presentation to the user; and
a second device which accepts the formatted listings information from the server and presents it to the user.

2. The system of claim 1 where there are at least two first devices.

3. The system of claim 1 where the first device is the same as the second device.

4. The system of claim 1 where the presenting client does not run on the same device as the server.

5. The system of claim 1 where the clients communicate with the server over a wide area network.

6. The system of claim 1 where the formatted listings information is presented in the form of a user preference grid.

7. A method of presenting program listings information in a two dimensional grid, the method comprising the steps of:
creating a two dimensional grid where one axis represents the time slots in which programs are available and a second axis represents a suggested preference order of the programs in each time slot; and
displaying the grid to a user.

8. A computer user interface for presenting programming listings information comprising:
instructions for creating a two dimensional grid where one axis represents the time slots in which programs are available and a second axis represents a suggested preference order of the programs in each time slot; and
instructions for displaying the grid to a user.

9. The computer user interface of claim 8 wherein the suggested preference order is determined, at least in part, based on personal preference information.

10. The computer user interface of claim 8 further comprising instructions to select a program and have all conflicting program options eliminated from the grid.

11. A displayed time-by-suggested preference program grid.

12. A data structure programmed to represent a time-by-suggested preference program grid.

13. A device for displaying a program grid to a user, the device programmed to:
receive program preference information; and
display a grid of programs with time as a first axis and suggested preference as a second axis.

14. The device of claim 12 further programmed to:
receive information on available programs; and
generate the display of the grid from the program preference information and the information on available programs.

15. The device of claim 12 or 13 wherein the program preference information is received from a user.

16. The device of claim 12 or 13 wherein the program preference information is received from a server.

17. A server for generating program preference information, the server programmed to:
send and receive program preference information;
send and receive information on available programs; and
generate and send data sufficient to create a grid of programs with time as a first axis and suggested preference as a second axis.
